(19) United States
(12) Patent Application Publication
(10) Pub. No.: US 2009/0027268 A1
(43) Pub. Date: Jan. 29, 2009

(54) Multi Beam Photonic Beamformer

(76) Inventor: James F. Coward, Portland, OR (US)

Correspondence Address: James F Coward, Suite 505, 650 5th Street, San Francisco, CA, 94107, US

(21) Appl. No.: 11/464,740

(22) Filed: Aug. 15, 2006

(51) Int. Cl. H01Q 3/22

(52) U.S. Cl. 342/375

(57) ABSTRACT

A true time delay beamformer for RF/microwave phased array antenna systems using multiple laser sources, optical modulators to convert the electrical signal to a modulated optical signal, standard optical fiber for creating time delays, dispersive optical fiber for creating delays, optical splitting and/or switching section, photodetectors to convert the modulated optical signal to an electrical signal, and a signal combining section. The true time delay beamformer has the capability to create multiple simultaneous RF/microwave antenna beams. One (more lasers) is used to source one (or more) wavelengths of light to the optical modulator. The signal from one (or more) antenna elements drive the optical modulator. The light from the optical modulator passes through the standard optical fibers and/or the dispersive optical fibers to create time delay variation for one optical modulator relative to another allowing for the formation of RF/microwave beams. Fixed location RF/microwave beams can be generated by a static network of standard and/or dispersive optical delay fibers. Steering of the location of the RF/microwave beams can be accomplished by an optical switching mechanism which could be based on MEMs and/or wavelength routing based switching. Finally, all the signals for a RF/microwave beam are summed to form a single output. The summing can occur either optically before the photodetectors and/or electrically after the photodetectors.

### BACKGROUND OF THE INVENTION

1. Field of the Invention

This invention relates generally to true time delay beamformer networks for RF/microwave/millimeter wave phased array antenna systems

2. Description of the Related Art

Phased-array antennas are becoming important elements in modem radar and communication systems. Phased-array antennas have many important advantages. They are capable of steering microwave beams quickly without physically moving the antennas; making two-dimensional steering with ease; receiving and transmitting multi-beams simultaneously; and controlling beam width and sidelobe power. They also degrade gracefully due to the large number of antenna element.

The generalized functional block diagram for an electronically steered phased array antenna is shown in FIG. 1. Each antenna radiating element typically has an associated transmit/receive (T/R) Module. The antenna elements and associated T/R modules are generally combined into sub-arrays. The sub-array outputs are connected to the microwave beamformer. To achieve wide bandwidth for a large aperture phased array antenna, the microwave beamformer would employ true-time delay. The microwave beamformer is connected to a microwave switch which allows connection of the desired microwave beam to the required receiver electronics. The radar support electronics include; radar signal processor, adaptive canceller, waveform generator, beam steering scheduler, etc.

One of the most important devices inside a true-time delay electronically steered phased array antenna is the true-time delay beamformer. A standard microwave true-time delay beamformer employs a Programmable Time Delay Unit (PTDU) per sub-array followed by a microwave combining network resulting in a signal that combines the output of the appropriately delayed outputs of the sub-arrays. A standard PTDU uses cascaded binary weighted switched delays as depicted in FIG. 2. The figure depicts a 4 bit PTDU. Namely, 24 or 16 different delay values can be generated ranging from 0τ to 15τ. For the 4 bit operation as shown in the figure, the signal must pass through 8 switches. For many low power density, large aperture, wide bandwidth applications, 8 bit PTDU operation is required necessitating 16 switches. Although the switched approach is architecturally simple, it does have many disadvantages. First, microwave switches are lossy, have high crosstalk, and are lack of good impedance matches—all of which will lead to a lower antenna sensitivity. Secondly, this PTDU generates only one delayed signal making multiple simultaneous microwave beam operation of a single antenna impossible. Thirdly, it requires a separate PTDU per sub-array per microwave beam. Thus, many PTDUs are required in the beamformer driving the size, weight and power of the antenna to beyond acceptable limits.

Photonic true time delay beamformers (PPTDB) are believed to have the potential of solving all the above mentioned issues. In the past fifteen years, many PPTDB architectures have been proposed and tested. Common approaches used to achieve true time delays in these PPTDBs are optical switches, fiber Bragg grating prisms, array waveguide gratings, free space with bulk optics and dispersive fibers.

For PPTDBs incorporating optical switches, MEMs or electro-optic switches are used. Although MEMs switches have low optical loss, they do have slow switching time. Electro-optic switches are fast but costly and high optical loss. Furthermore, one PTDU is needed per subarray and one PTDU requires many switches. For PPTDBs incorporating fiber Bragg grating prisms, fiber Bragg gratings are used. Fiber Bragg gratings have the advantages of compactness and excellent reliability. But they have optical loss on the order of several dB. They also have high loss variation that means a different optical loss for a different time delay. Another type of PPTDBs is array waveguide grating based PPTDBs. These PPTDBs are easy to make and have very fine time delay resolutions but have high optical loss and require 1 PTDU per subarray. A PPTDB made of bulk optics has a very important advantage that it requires only 1 PTDU per beamformer. Unfortunately, this PPTDB requires very precise and costly optics. It also has a stability issue. A heavy, stiff, bulky and temperature compensated optical mounting table is needed! A PPTDB using dispersive fibers has the same important advantage as a bulk optics PPTDB. It needs only 1 PTDU per beamformer. However, this PPTDB requires tunable lasers with wide tuning range and it also has high optical loss.

There are many other less common PPTDB architectures considered by scientists and engineers. However, they all have different but important issues preventing them from being used to construct functional but practical beamformers needed for nowadays radar and communications systems. Thus, a need continues to exist for photonic programmable true time delay beamformers that are compact, light weight, low loss, highly reliable, very efficient and highly sensitive.

### SUMMARY OF THE INVENTION

The present invention is particularly advantageous because current true time delay beamformer technology has very high optical loss driving up system power and degrading system spur free dynamic range. The present invention provides a large range of time values by passing through only one active switch element. Additionally, the total parts count of the present invention is lower than current beamformer technology simplifying the system design, reducing system cost and improving system reliability.

### BRIEF DESCRIPTION OF THE DRAWING

The invention has other advantages and features which will be more readily apparent from the following detailed description of the invention and the appended claims, when taken in conjunction with the accompanying drawing, in which:

FIG. 1 is a generalized block diagram of an electronically steered phased array antenna;

FIG. 2 (prior art) is a diagram of a standard cascaded binary switch time delay unit;

FIG. 3 is a diagram of the operating principle of present invention photonic true time delay beamformer

FIG. 4 is a diagram for multi RF/microwave beam operation of the beamformer

FIG. 5 is a diagram for the Multi-wavelength Laser source using parallel lasers

FIG. 6 is a diagram of the Multi-wavelength Acousto-optic External Cavity laser source

FIG. 7 is a diagram of optical wavelength plan

FIG. 8 is a diagram of the Band Separator Signal Combiner (BSSC) Operation for a preferred embodiment

FIG. 9 is a diagram of the Multibeam beamformer operation for a preferred embodiment

FIG. 10 is a diagram of a preferred embodiment of the BSSC

FIG. 11 is a diagram of a preferred embodiment of the BSSC.

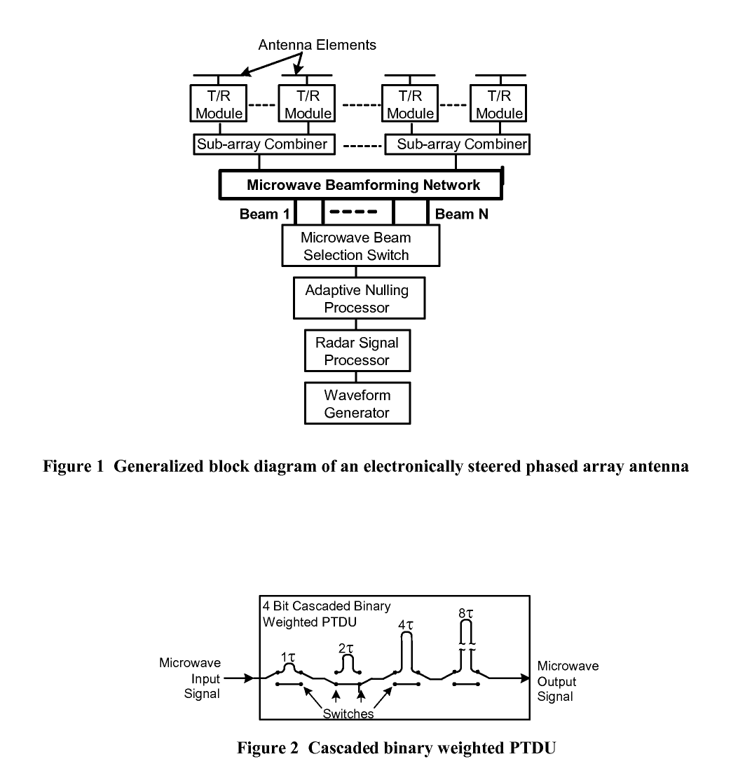

### DETAILED DESCRIPTION OF THE PREFERRED EMBODIMENTS

### Introduction

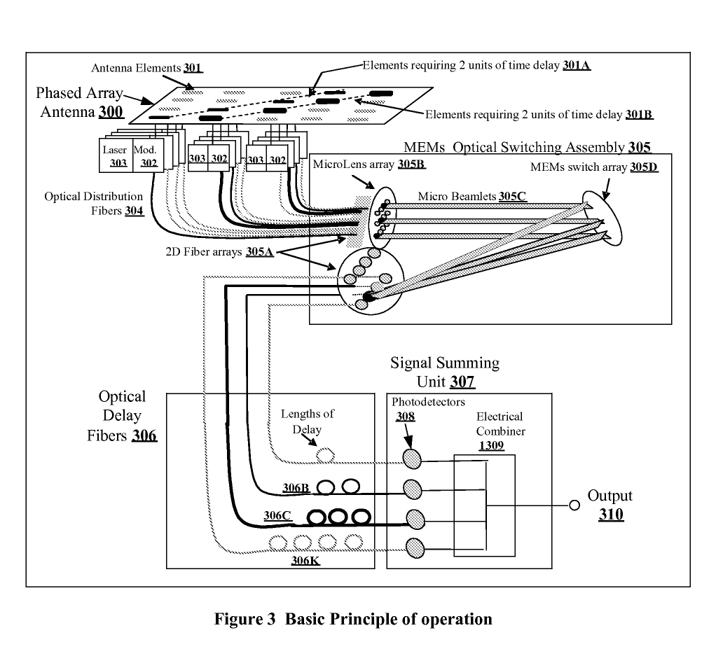

The basic concept for the antenna receive function is shown in FIG. 3. The present invention is for beamforming for phased array antennas. The phased array antenna 300 receives the incident RF/microwave energy. Antenna elements 301 convert the energy from the impinging RF/microwave beam into an electrical signal that drives the optical modulator 302. An optical laser source 303 provides continuous wave (CW) optical power to the modulator. The optical modulator converts the CW optical power into a optically modulated signal corresponding to the electrical drive signal from the antenna element. The modulated optical signal is transported via optical distribution fiber 304 to the MEMs optical switch assembly 305 (MOSA). For an antenna with M antenna elements, there would be M optical modulators and M optical fibers.

The MOSA has M input fibers. The output of the MOSA is attached to optical delay fibers 306. The number of delay fibers, K, varies from one beamformer application to another with the typical range being between 32 to 256. The MOSA can switch the light from any one of the M input fibers to any one of the K delay fibers. Furthermore, the MOSA can switch the signals from multiple input fibers into any single one of the K delay fibers.

The delay fibers are attached to a signal summing unit 307 (SSU). The SSU depicted in FIG. 3 utilizes a photodetector 308 per each delay fiber to convert the modulated optical signal to an electrical signal. As depicted in FIG. 3, the outputs from the K photodetectors impinge on an electrical combiner (EC) 309 which combines all K signals into a single output signal 310.

The MOSA 305 takes the M input fibers and groups them into a fiber array 305A. Light exiting from the fibers in the fiber array impinge on a microlens array 305B. The microlens array has a lens element for each of the M input channels. The lens approximately for a particular input fiber approximately collimates the light into a beamlet 305C. The M beamlets are directed onto a MEMs switch array 305D. The MEMs switch array has a switch element per beamlet. The switch element for any particular beamlet can steer the input light into any of the output delay fibers.

To steer a RF/microwave beam any particular direction requires that a set of elements have certain time delay. FIG. 3 depicts forming a RF/microwave beam such that the elements 301A all require 2 unit of time delay. The MOSA is then directed to direct the light from all of the 301A elements into delay fiber 306B. The beamlets (305C) for the elements requiring 2 units of delay are depicted in FIG. 3. Antenna elements 301B require 3 units of delay. The MOSA steers the light from the 301B elements into delay fiber 306C. For a different steering angle of the RF/microwave beam, different elements would require 2 units of delay. The MOSA would then be commanded to direct the light from the elements that require 2 units of delay for the different steering angle.

The prior art beamforming approaches require up to 17 switches per antenna element and up to 8 delay fibers per element. Each time the light passes through a switch there is optical loss and unwanted crosstalk. Each time light is coupled into and out of a delay fiber there is additionally optical loss.

At this point, the advantage of the present invention becomes apparent. Light from an antenna element passes through only one optical switching element. Furthermore the light from any one element passes in and out of only one delay fiber. This greatly reduces optical loss and beamformer parts count.

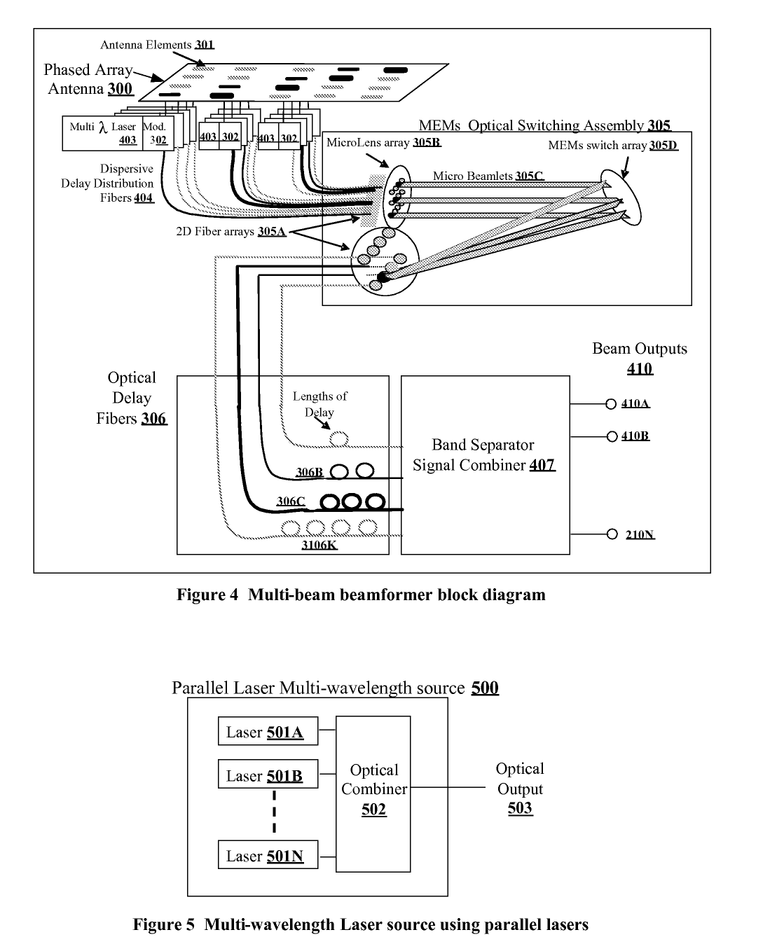

Most modern phased array antenna systems require multiple simultaneous RF/microwave beams formations. FIG. 4 depicts the basic preferred implementation of the present invention for multiple simultaneous RF/microwave beam formation.

In FIG. 4, the single wavelength laser source 303 from FIG. 3 is replaced with a multi wavelength laser source 403. The multi-wavelength laser source 403 (MLS) is capable of producing N simultaneous wavelength which each of the N wavelengths corresponding to one of the N RF/microwave beams. Also in FIG. 4, the standard optical distribution fiber 304 is replaced with dispersive delay fiber 404. Finally, the Signal Summing Unit 307 is replaced with a Band Separator Signal Combiner unit 407 (BSSC). The BSSC has K inputs corresponding to the K delay fibers (306A through 306K). It separates the light into N bands and then sums the signals in each band to produce N outputs each corresponding to one RF/microwave beam.

FIG. 5 depicts one preferred implementation of the multi-wavelength laser source 403. This implementation is called the Parallel Laser Multi-wavelength 500 (PLM) source. In the PLM, N individual lasers, 501A through 501N, are used to create the N simultaneous wavelengths. The outputs from 501A through 501N are combined by an optical combiner 502. The optical combiner can either be a standard wavelength independent optical combiner or an optical wavelength division multiplexing combiner.

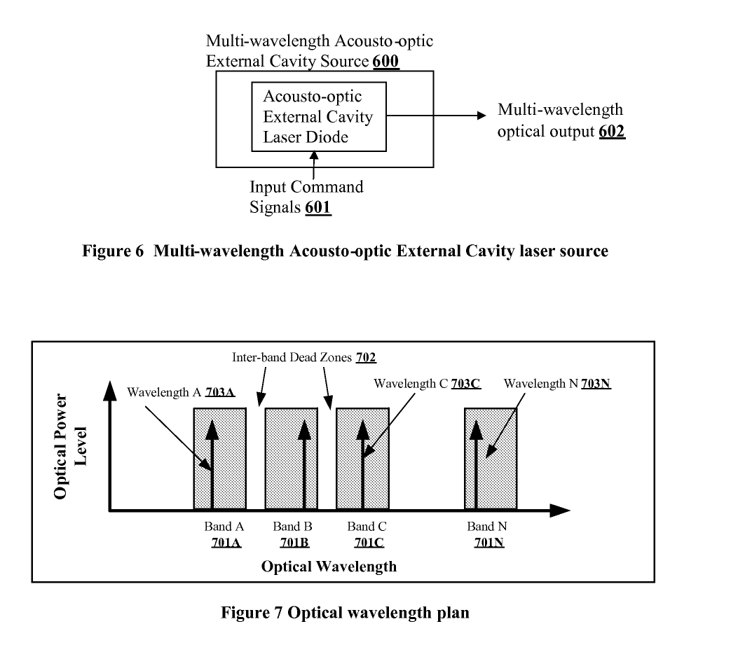

FIG. 6 depicts one preferred implementation of the multi-wavelength laser source 403. This implementation is called the Multi-wavelength Acousto-optic External Cavity 600 (MAEC) source. Acousto-optic external cavities lasers have the capability of producing multiple simultaneous wavelengths which are independently controllable via the insertion of N command signals 601 resulting in an optical output with N wavelengths 602.

The N wavelengths are separated into N wavelength bands as depicted in the wavelength plan 700 shown in FIG. 7. All the wavelengths for RF/microwave beam 1 reside in band 701A. All the wavelengths for beam 2 reside in band 701B etcetera through band N. For fixed location RF/microwave beam positions, fixed wavelengths can be utilized in each wavelength band. To allow steering of RF/microwave beam 1, the wavelengths will be varied within band A

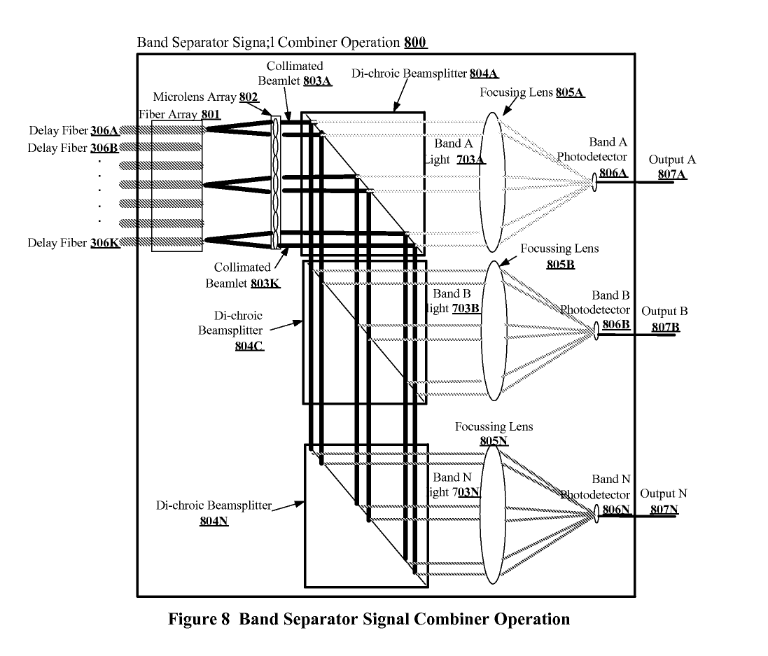

FIG. 8 is a diagram of the operation of the Band Separator Signal Combiner. Light enters from the delay fibers 306A through 306K. The fibers are bundled into a fiber array 801. Light exits each fiber of the fiber array and impinges onto a microlens array 802. Each lens of the microlens array nominally collimated the light from the corresponding fiber to create collimated beamlets 803A through 803K. The light in beamlets 803A through 803K contains all N bands of light. The beamlets impinge onto a dichroic beamsplitter 804A. Beamsplitter 804A passes the Band A light 703A and reflects the light of bands 703B through 703N. The micro beamlets with light in band 703A impinge on a focusing lens 805A. The focusing lens directs all the light in 703A onto the Band A photodetector 806A. The photodetector converts the optical signal into an electrical signal resulting in the beam A output 807A.

The light reflected by beamsplitter 804A impinges onto a second beamsplitter 804B. Beamsplitter 804B reflects all of the band B 703B light and passes band 703C through 703N. The reflected 703B light impinges onto a second focusing lens 805B. The focusing lens directs the light onto photodetector 806B which converts the optical signal into the beam B output 807B.

This process continues for the remainder of the N beams.

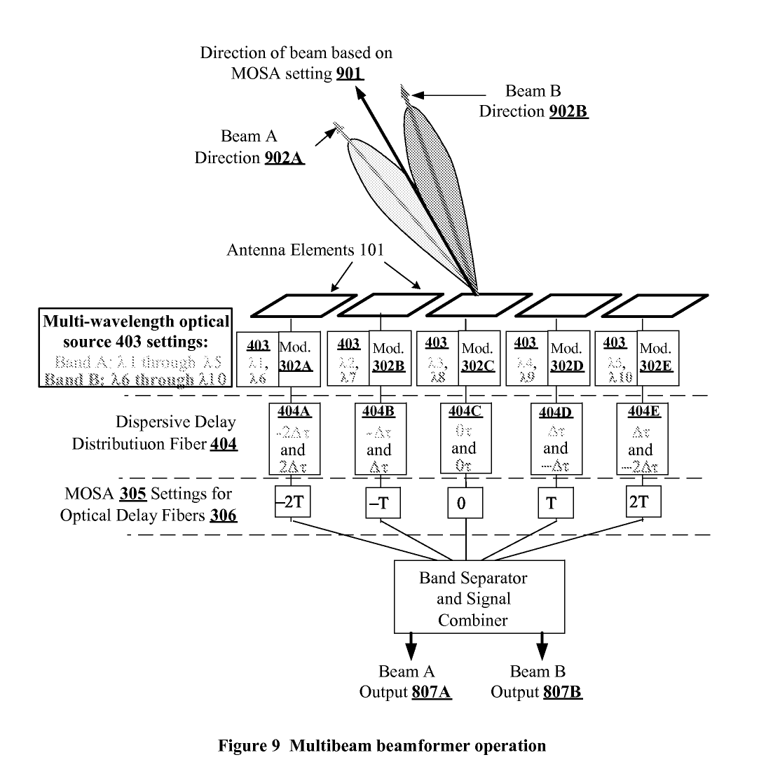

FIG. 9 is a diagram of the operation of the beamformer multi-beam operation. FIG. 9 depicts the formation of two RF/microwave beams 902A and 902B around the nominal pointing direction 901 based on the settings of the MOSA 305. To achieve the formation of these two beams the Multi-wavelengths Laser Sources 403 (MLS) are configured for two bands of light 703A and 703B. Wavelengths λ1 through λ5 are in band A. Wavelengths λ6 through λ10 are in band B. The MLS for modulator 302A is commanded to produce wavelengths λ1 and λ6 such that the delay through dispersive delay distribution fiber 404A is −2Δτ for band A and +2Δτ for band B. The light from 404A then passes through the MOSA 305 and the optical delay fiber. The BSSC separates λ1 into the band A summing section where it is summed with wavelengths λ2 through λ5 to form output 807A for beam A. Wavelengths λ2-λ5 and λ7-λ10 are chosen to create the delays depicted in dispersive distribution fibers 404B through 404E.

At this point, the advantage of the present invention for multiple beam operation becomes apparent. For multiple RF/microwave operation, light from an antenna element passes through only one optical switching element. Furthermore the light from any one element passes in and out of only one delay fiber. This greatly reduces optical loss and beamformer parts count.

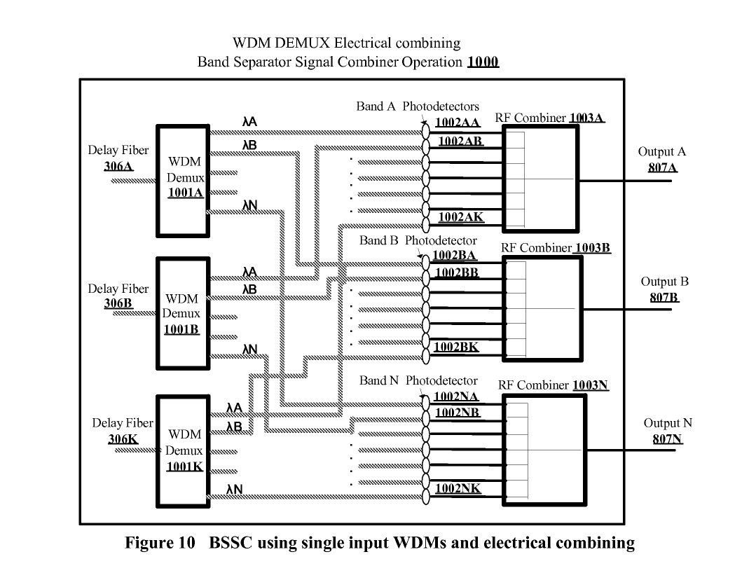

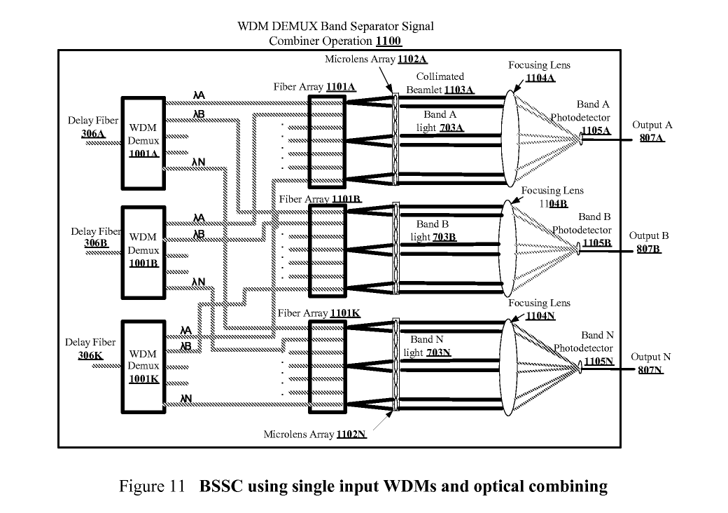

FIG. 9 shows a preferred embodiment when M and/or K are large. When M or K are less than 20-30 a second preferred embodiment of the Band Separator Signal Combiner is shown in FIG. 10 is to uses standard single input channel wavelength division multiplexers 1001 (WDMs) for the band separation. Each WDM has single input from one of the delay fibers 306A through 306K. The WDM breaks the light into wavelength band components λA through λN. The K optical fibers for band A are directed to the band A photodetectors 1002AA through 1002AK which convert the light into electrical signals. The electrical signals from photodetectors 1002AA through 1002AK are summed by an electrical combining unit 1003A resulting in the BSSC band A output of 807A. As shown in FIG. 10, the operation is similar for bands B through N.

FIG. 11 shows a second preferred embodiment of the BSSC when M and/or K are les than 20-30. Single input WDMs 1001A through 1001K are used again. The output fibers for band A from the WDM are grouped into a fiber array 1101A. A microwlens array 1102A is used ti nominally collimate the outputs out of the fiber array 1101A producing a set of collimated beamlets 1103A. A focusing lens 1104A is used to focus the band A beamlets down onto the band A photodetector 1105A resulting in the band A BSSC output signal 807A. Similar operation is implemented for bands B through N.

What is claimed is:

1. An optical true time delay beamformer comprising:
(a) an optical source capable of producing one or more optical wavelengths,
(b) a modulator to convert the incoming electrical signal to a modulated optical signal; The modulator is capable of simultaneously modulating multiple optical wavelengths with each wavelength carrying the information of a different microwave beam
(c) standard optical fiber delay media; The standard optical delay media provides uniform delay for the multiple optical wavelengths
(d) dispersive optical fiber delay media; The dispersive optical delay media creates a delay variation as a function of source wavelength
(e) a splitting network capable of separating the optical signals for each microwave beam
(f) a set of summing networks to add multiple optical signals into a single output signal per microwave beam
(g) photodetectors to convert the resultant optical signal to an output electrical signal per microwave beam

2. The multi-beam true time delay beamforming network of claim 1 wherein:
(a) one optical switching mechanism is utilized to allow variation of the time delay to permit steering of the microwave beams.

3. The multi-beam true time delay beamforming network of claim 1 wherein:
(a) more than one optical switching mechanisms are utilized to allow variation of the time delay to permit steering of the microwave beams.

4. The multi-beam true time delay beamforming network of claim 1 wherein:
(a) the optical source comprising a collection of lasers at different optical frequencies.

5. The multi-beam true time delay beamforming network of claim 1 wherein:
(a) The frequency of the optical source can be tuned electronically.

6. The multi-beam true time delay beamforming network of claim 1 wherein:
(a) The frequencies of the optical source can be tuned electronically.

7. The switching network of claim 2 comprised of:
(a) MEMs photonic cross connect mechanism consisting of M input fibers and Y output fibers where Y is the required number of delay variations.

8. The switching network of claim 2 comprised of:
(a) a tunable optical source coupled with the dispersive optical fiber of claim 1 that results in a change of the signal delay as a function of the optical source wavelength.

9. The switching network of claim 2 comprised of a combination of:
(a) MEMs photonic cross connect mechanism consisting of M input fibers and Y output fibers where Y is the required number of delay variations.
(b) a tunable optical source coupled with the dispersive optical fiber of claim 1 that results in a change of the signal delay as a function of the optical source wavelength.

10. A combined switching and combining network comprised of:
(a) MEMs photonic cross connect switch with M input single mode fibers and Y output multii-mode fibers where the signal from any one or more of the M input fibers can be switched to any of the Y output fibers.

11. A method of forming a microwave beam, the method comprising:
(a) generating optical signals with multiple wavelengths;
(b) receiving multiple microwave beams;
(c) converting multiple microwave beams to optical signals;
(d) producing uniform delays of the optical signals;
(e) creating a delay variation of the optical signals;
(f) splitting the optical signals for each microwave beam;
(h) converting the optical signals into electrical signals.

12. The method of claim 7 wherein:
(a) generating optical signals multiple wavelengths using a single laser source capable of producing multiple simultaneous output wavelengths;

13. The method of claim 8 wherein:
(a) wavelengths generated by the laser source can be adjusted.

14. The method of claim 7 wherein:
(a) generating optical signals multiple wavelengths using multiple single wavelength tunable laser sources:

15. The method of claim 10 wherein:
(a) each tunable laser source produces a single wavelength.

16. The method of claim 11 wherein:
(a) the wavelength of the laser source can be adjusted.

17. The method of claim 10 wherein:
(a) generating one fixed optical wavelength in each laser source.

18. The method of claim 7 wherein:
(a) using broadband 1:N fiber optic splitters to split the optical signals where N is the number of desired microwave beams.

19. The method of claim 7 wherein:
(a) using an N channel optical wavelength division multiplexing (WDM) network where N is the number desired optical beams.

20. The method of claim 7 wherein converting the optical signals into electrical signals by:
(a) summing the optical signals by focusing them onto a single photodetector.

21. The method of claim 7 wherein converting the optical signals into electrical signals by:
(a) summing the optical signals by an M:1 fiber optic combiner where M is the number of optical signals to be combined corresponding to the number of electrical signal sources;
(b) detecting the optical signal from the said combiner with a photodetector.

22. The method of claim 7 wherein converting the optical signals into electrical signals by:
(a) detecting optical signals with M detectors;
(b) electrically combining the output signals of the detectors.

23. The method of claim 7 wherein separating the optical signals by:
(a) M WDM units where each of the M units has one input and N outputs.

24. The method of claim 7 wherein separating the optical signals by:
(a) an M by N WDM unit that simultaneously takes in M input signals and in parallel creates N wavelength output bands.
